(19) United States
(12) Patent Application Publication
(10) Pub. No.: US 2026/0163246 A1
(43) Pub. Date: Jun. 11, 2026

(54) RADIO WAVE LENS

(71) Applicant: NTT, Inc., Tokyo (JP)

(72) Inventors: Daisuke Kitayama, Tokyo (JP); Adam Pander, Tokyo (JP); Hiroyuki Takahashi, Tokyo (JP)

(21) Appl. No.: 19/126,840

(22) PCT Filed: Nov. 4, 2022
(86) PCT No.: PCT/JP2022/041187

§ 371 Date: May 2, 2025

(51) Int. Cl. H01Q 15/00

(52) U.S. Cl. CPC H01Q 15/002; H01Q 15/0086

(57) ABSTRACT

An embodiment is a radio wave lens including a plurality of unit cells two-dimensionally arranged on a surface of a substrate intersecting an incident radio wave. Each of the unit cells includes a dielectric layer whose dielectric constant is externally controllable, dielectric layers formed so as to sandwich the dielectric layer therebetween, a conductor layer formed on a surface of the dielectric layer in a side of the dielectric layer so as to be in contact with the dielectric layer, and a conductor layer formed on a surface of the dielectric layer in a side of the dielectric layer so as to be in contact with the dielectric layer.

### CROSS-REFERENCE TO RELATED APPLICATIONS

This application is a national phase entry of PCT Application No. PCT/JP2022/041187, filed on Nov. 4, 2022, which application is hereby incorporated herein by reference.

### TECHNICAL FIELD

The present disclosure relates to a radio wave lens that controls a transmission intensity distribution or a reflection intensity distribution of a radio wave.

### BACKGROUND

Radio waves in the millimeter wave band and the terahertz wave band used in the fifth generation mobile communication system (5G) and the sixth generation mobile communication system (6G) have high rectilinearity, and are weak in wraparound. Therefore, the communication quality is greatly affected by the shielding object, and the communication quality is significantly deteriorated in the non-line-of-sight area from the base station. This deterioration in the communication quality is a problem when an outdoor base station makes an indoor area as communication area through the window of a building.

In recent years, a technology of guiding a radio wave in a desired direction by attaching a film or the like having a lens function to a window glass with a metasurface technology capable of designing scattering characteristic distribution of a planar incoming wave (refer to, for example, Patent Literature 1 and Non Patent Literature 1) has attracted attention. FIG. 21 illustrates a situation where radio waves from a base station 103 are reflected by an outdoor metasurface pattern 100 and guided to a mobile terminal 104a, and a situation where radio waves are reflected by the metasurface pattern 100 attached to a window glass 105 and guided to an indoor mobile terminal 104b.

In Non Patent Literature 1, a film on which a metal metasurface pattern 100 illustrated in FIG. 22 is formed is attached to a window glass to form the distribution of radio wave transmission and reflection on the window glass surface, and thus a desired planar transmission intensity distribution 101 (binary distribution of 1 (transmission) and o (reflection)) is achieved. In Patent Literature 1, in order to achieve a more efficient lens function, a binary transmission phase distribution 102 of o and π[rad] is formed by the metasurface pattern 100 to achieve a radio wave lens function.

Furthermore, it is also studied to dynamically control the transmission intensity distribution or the phase distribution of the radio wave in order to guide the radio wave so as to follow the position of the mobile terminal that changes from moment to moment. For example, in the technology disclosed in Non Patent Literature 2, liquid crystal is used as a functional material and combined with a metasurface technology, and thereby, dynamic control of the transmission intensity of a radio wave is achieved.

However, when a liquid crystal material mainly used for an optical display is used in a millimeter wave band or a terahertz wave band having a long wavelength with respect to light, there is a problem that a required thickness of liquid crystal increases. For example, in the technology disclosed in Non Patent Literature 2, a structure in which a liquid crystal layer is sandwiched between two metasurface resonators is used, and the transmission intensity of a radio wave in a 400 GHz band is controlled by controlling a hybrid resonance mode between layers by a change in a dielectric constant of the liquid crystal layer. In this case, the thickness of the liquid crystal layer is about 50 μm, which is much thicker than the thickness (around 4 μm) of the liquid crystal layer of the optical display.

When the liquid crystal layer becomes thick, problems such as an increase in driving voltage, a decrease in response speed, and incompatibility with a manufacturing process of an existing optical display occur.

Furthermore, in order to control the propagation direction of the incoming wave as desired, it is necessary to control a two-dimensional planar intensity distribution. In order to achieve this control, vertical and horizontal matrix control signal lines are required, but the control signal lines having a component parallel to the electric field direction of the incoming wave inhibit coupling between the metasurface resonator and the incoming wave, which causes a large loss.

### CITATION LIST

### Patent Literature

Patent Literature 1: JP 2019-41138 A

### Non Patent Literature

Non Patent Literature 1: Daisuke Kitayama, et al., “Transparent dynamic metasurface for a visually unaffected reconfigurable intelligent surface:controlling transmission/reflection and making a window into an RF lens”, Optics Express, vol. 29, No. 18, pp. 29292-29307, 2021
Non Patent Literature 2: Jun Yang, et al., “Electrically tunable liquid crystal terahertz device based on double-layer plasmonic metamaterial”, Optics Express, vol. 27, No. 19, pp. 27039-27045, 2019

### SUMMARY

### Technical Problem

An object of embodiments of the present invention is to dynamically control a transmission intensity distribution or a reflection intensity distribution of a radio wave by a dielectric layer made of a functional material having a thickness equivalent to that of a liquid crystal used in an optical display in a millimeter wave band or a terahertz wave band.

### Solution to Problem

A radio wave lens of embodiments of the present invention include a plurality of unit cells arranged two-dimensionally on a surface of a substrate intersecting an incident radio wave, and each of the unit cells includes: a first dielectric layer whose dielectric constant is externally controllable; second and third dielectric layers formed so as to sandwich the first dielectric layer therebetween; a first conductor layer formed on a surface of the second dielectric layer in a side of the first dielectric layer so as to be in contact with the first dielectric layer; and a second conductor layer formed on a surface of the third dielectric layer in a side of the first dielectric layer so as to be in contact with the first dielectric layer.

### Advantageous Effects

According to embodiments of the present invention, with a unit cell of a radio wave lens having a stacked structure of first, second, and third dielectric layers and first and second conductor layers, a large change in a resonance frequency of a resonator can be achieved even with a change in a dielectric constant of the first dielectric layer that is thin, a transmission intensity distribution or a reflection intensity distribution of the radio wave can be controlled, and the radio wave can be guided in a desired direction.

### BRIEF DESCRIPTION OF THE DRAWINGS

FIGS. 1A and 1B are cross-sectional views for explaining a method of forming a capacitive component in a structure in which a functional material is sandwiched between two dielectric substrates.

FIGS. 2A and 2B are diagrams illustrating an influence of a dielectric constant change of a functional material on a resonance characteristic of a resonator.

FIG. 3 is a cross-sectional view of a unit cell of a radio wave lens according to a first embodiment of the present invention.

FIG. 4 is a plan view of the unit cell of the radio wave lens according to the first embodiment of the present invention.

FIG. 5 is a plan view illustrating a pattern of a conductor layer of the unit cell according to the first embodiment of the present invention.

FIG. 6 is a plan view illustrating the pattern of the conductor layer of the unit cell according to the first embodiment of the present invention.

FIG. 7 is a cross-sectional view of a unit cell of a radio wave lens according to a second embodiment of the present invention.

FIG. 8 is a plan view illustrating the pattern of the conductor layer of the unit cell according to the second embodiment of the present invention.

FIG. 9 is a plan view illustrating the pattern of the conductor layer of the unit cell according to the second embodiment of the present invention.

FIG. 10 is a plan view of the radio wave lens according to a third embodiment of the present invention.

FIG. 11 is a diagram illustrating a state determination method of a unit cell according to the third embodiment of the present invention.

FIG. 12 is a diagram illustrating a state determination method of a unit cell according to a fourth embodiment of the present invention.

FIG. 13 is a cross-sectional view of a unit cell according to a fifth embodiment of the present invention.

FIG. 14 is a plan view of the unit cell according to the fifth embodiment of the present invention.

FIG. 15 is a plan view illustrating a pattern of a conductor layer and a control signal line of the unit cell according to the fifth embodiment of the present invention.

FIG. 16 is a plan view illustrating a pattern of a conductor layer and a control signal line of the unit cell according to the fifth embodiment of the present invention.

FIG. 17 is a perspective view illustrating a model of a unit cell 1a used in an electromagnetic field analysis simulation.

FIG. 18 is a diagram illustrating a transmitted wave intensity characteristic of a unit cell in a case where there is no control signal line.

FIG. 19 is a diagram illustrating a transmitted wave intensity characteristic of a unit cell in a case where a control signal line made of copper is formed.

FIG. 20 is a diagram illustrating a transmitted wave intensity characteristic of a unit cell in a case where a control signal line made of ITO is formed.

FIG. 21 is a diagram for explaining a use example of a technology of guiding a radio wave in a desired direction.

FIG. 22 is a diagram for explaining a conventional transmission intensity distribution type radio wave lens and a transmission phase distribution type radio wave lens.

### DETAILED DESCRIPTION OF ILLUSTRATIVE EMBODIMENTS

Embodiments of the present invention proposes a structure in which a liquid crystal layer is sandwiched in a capacitive component forming portion in a single resonator structure rather than a structure in which the liquid crystal layer is sandwiched between two metasurface resonators. This makes it possible to achieve a large change in resonance characteristics even with a change in a dielectric constant of the liquid crystal layer that is thin.

In addition, the metasurface structure is formed of two types of conductive materials, and a control signal line is formed of a material having higher resistance than a portion through which a radio frequency (RF) signal is desired to flow. Accordingly, even when the control signal line having the component parallel to the electric field direction is formed, the planar transmission intensity distribution of the radio wave can be efficiently controlled.

### First Embodiment

Consideration is given to using a metal resonator as a unit cell constituting a metasurface that is a two-dimensional periodic structure. An inductive component L and a capacitive component C are formed by the structure of the resonator. In embodiments of the present invention, the capacitive component C is changed by a change in a dielectric constant of a functional material whose dielectric constant is externally controllable. A resonance frequency fᵣ of the resonator can be controlled by a change in the capacitive component C, and the scattering characteristic of the radio wave arriving at the metasurface can be controlled.

$$\begin{matrix}[ Math . 1 ] & \\ {f}_{r} = \frac{1}{2 π \sqrt{LC}} & ( 1 )\end{matrix}$$

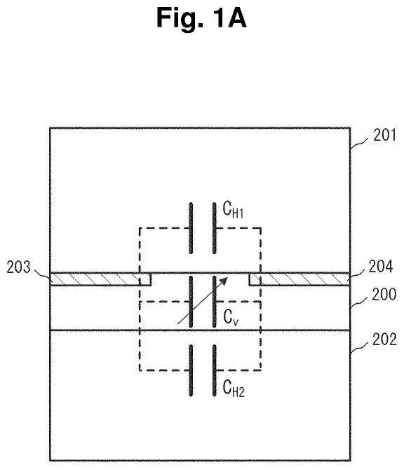

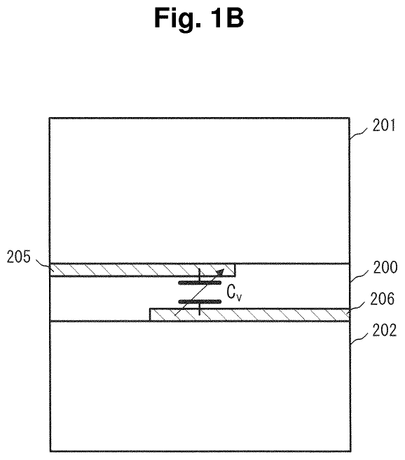

As a method of forming the capacitive component C, a method of forming the capacitive component C between metals formed on one of the two dielectric substrates sandwiching the functional material and a method of forming the capacitive component C between metals formed on each of the two dielectric substrates are considered. FIG. 1A is a cross-sectional view of a structure in which metal layers 203, 204 are formed on one substrate 201 of two dielectric substrates 201, 202 sandwiching a dielectric layer 200 made of a functional material. FIG. 1B is a cross-sectional view of a structure in which metal layers 205, 206 are formed on each of two dielectric substrates 201, 202.

In the case of the structure of FIG. 1A, the capacitive component C formed between the metal layers 203, 204 has a value in which the capacitance C_{H}=C_{H1}+C_{H2} formed via the dielectric substrate 201, 202 in which the dielectric constant does not change and the capacitance Cᵥ formed via the dielectric layer 200 in which the dielectric constant changes are connected in parallel. In this case, the resonance frequency fᵣ of the resonator is expressed by Expression (2).

$$\begin{matrix}[ Math . 2 ] & \\ {f}_{r} = \frac{1}{2 π \sqrt{L ( {C}_{H} + {C}_{V} )}} & ( 2 )\end{matrix}$$

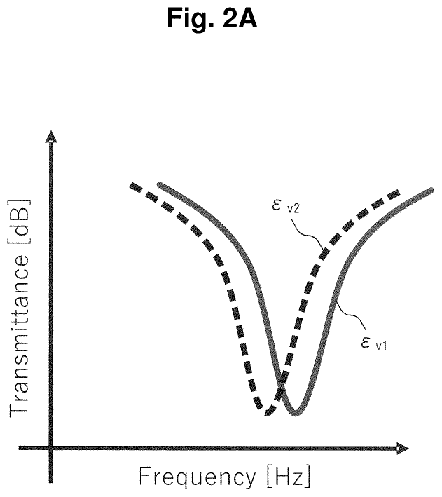

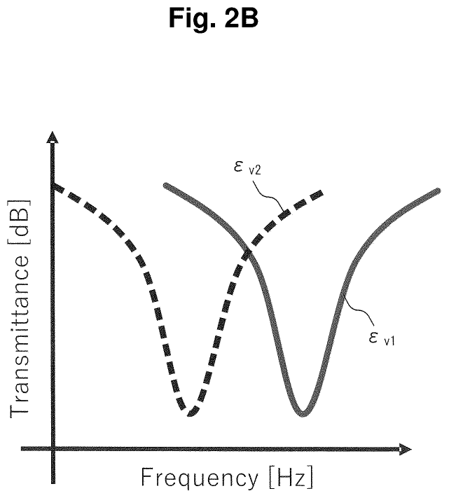

According to Expression (2), it can be seen that the change in the resonance frequency fᵣ due to the change in the capacitance C, is inhibited by the capacitance C_{H}. Therefore, even if the dielectric constant of the dielectric layer 200 changes from εᵥ₁ to εᵥ₂ as illustrated in FIG. 2A, a large change does not appear in the resonance characteristics of the resonator.

On the other hand, in the case of the structure of FIG. 1B, the capacitive component C formed between the metal layers 205, 206 is the capacitance Cᵥ formed via the dielectric layer 200, and the resonance frequency fᵣ is as expressed in Expression (3). In the case of the structure of FIG. 1B, when the dielectric constant of the dielectric layer 200 changes from εᵥ₁ to εᵥ₂ as illustrated in FIG. 2B, the resonance characteristics of the resonator largely changes. Therefore, even if the dielectric layer 200 is thin, a large change in the resonance frequency fᵣ can be obtained.

$$\begin{matrix}[ Math . 3 ] & \\ {f}_{r} = \frac{1}{2 π \sqrt{{LC}_{V}}} & ( 3 )\end{matrix}$$

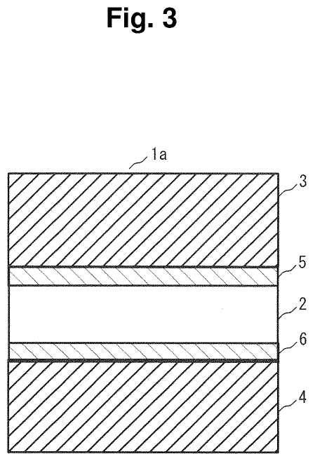

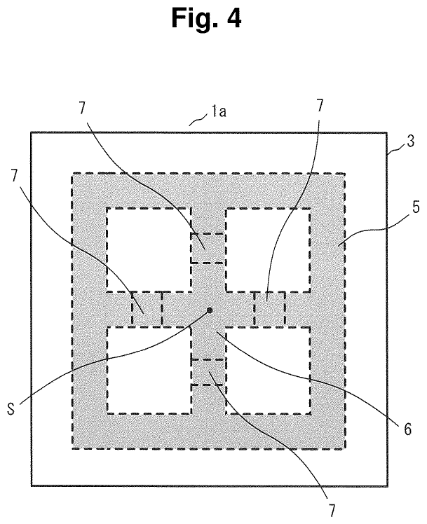

FIG. 3 is a cross-sectional view of a unit cell and FIG. 4 is a plan view of the unit cell of a radio wave lens according to the present embodiment. FIG. 4 illustrates an upper surface of the unit cell in a perspective view. A unit cell 1a, which is a resonator whose resonance frequency varies depending on a capacitive component, includes: a dielectric layer 2 made of a functional material such as liquid crystal, for example; two dielectric layers 3, 4 made of glass, for example, formed so as to sandwich the dielectric layer 2; a conductor layer 5 made of metal formed on a surface of the dielectric layer 3 on the dielectric layer 2 side so as to be in contact with the dielectric layer 2; and a conductor layer 6 made of metal formed on a surface of the dielectric layer 4 on the dielectric layer 2 side so as to be in contact with the dielectric layer 2.

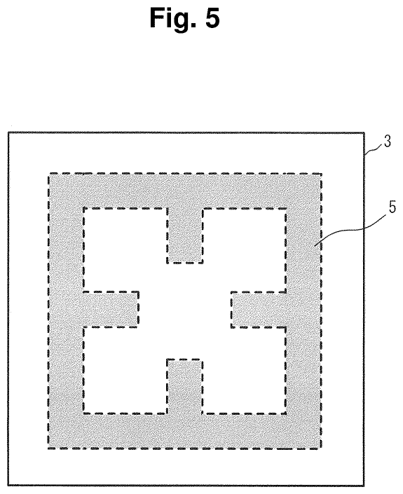

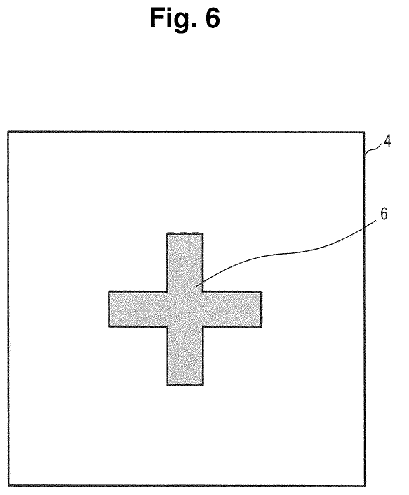

FIG. 5 is a plan view illustrating a pattern of the conductor layer 5, and FIG. 6 is a plan view illustrating a pattern of the conductor layer 6. In the present embodiment, the conductor layers 5, 6 constitute a metasurface pattern. A capacitive component of the resonator is formed in an overlapping portion (portion 7 in FIG. 4) where the pattern of the conductor layer 5 and the pattern of the conductor layer 6 face each other with the dielectric layer 2 interposed therebetween. The unit cell 1a has a four-fold rotational symmetry structure with respect to a rotation axis (S in FIG. 4) perpendicular to the stacked structure in FIG. 3. As a result, it is possible to operate as a radio wave lens regardless of the polarization of the incoming radio wave.

When a radio wave (incoming wave) is incident from a direction intersecting a surface (sheet surface of FIG. 4) on which the metasurface pattern is formed, an incoming wave having a frequency near the resonance frequency of the unit cell 1a is reflected without being transmitted through the unit cell 1a. On the other hand, incoming waves in a frequency domain other than the resonance frequency are transmitted through the unit cell 1a. By changing the dielectric constant of the dielectric layer 2 depending on the position of the unit cell 1a, that is, by changing the resonance frequency of the unit cell 1a, the intensity distribution of the transmitted wave and the intensity distribution of the reflected wave in the vicinity of the resonance frequency can be changed. A control signal line is required to change the dielectric constant of the dielectric layer 2, and the control signal line will be described later.

### Second Embodiment

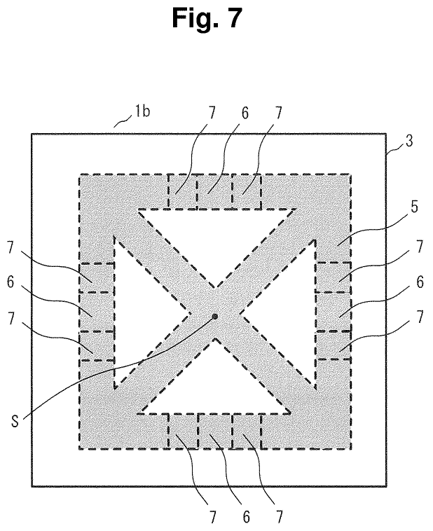

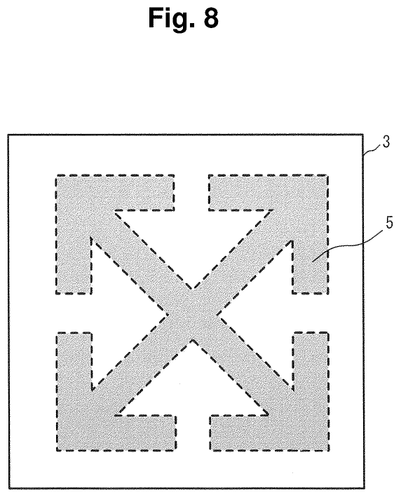

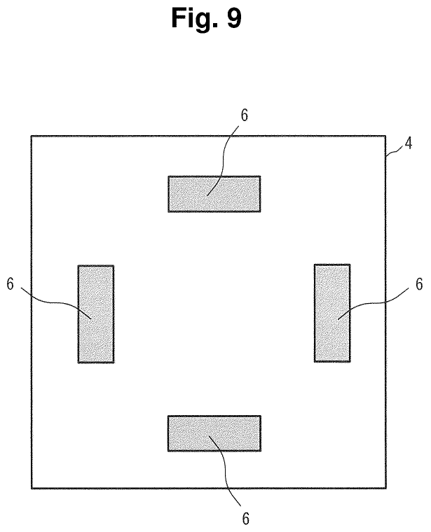

The present embodiment illustrates an example of a metasurface pattern different from that of the first embodiment. FIG. 7 is a plan view of a unit cell 1b of the present embodiment. As similar to FIG. 4, FIG. 7 illustrates an upper surface of the unit cell 1b in a perspective view. FIG. 8 is a plan view illustrating a pattern of the conductor layer 5, and FIG. 9 is a plan view illustrating a pattern of the conductor layer 6. Since the stacked structure of the unit cell 1b is similar to that of the unit cell 1a, each component of the unit cell 1b is denoted by the same reference numeral as that of the unit cell 1a. The same effect as that of the first embodiment can be obtained by the metasurface pattern as in the present embodiment.

In the first and second embodiments, an alignment layer may be inserted between the dielectric layer 2 and the conductor layer 5 or between the dielectric layer 2 and the conductor layer 6.

### Third Embodiment

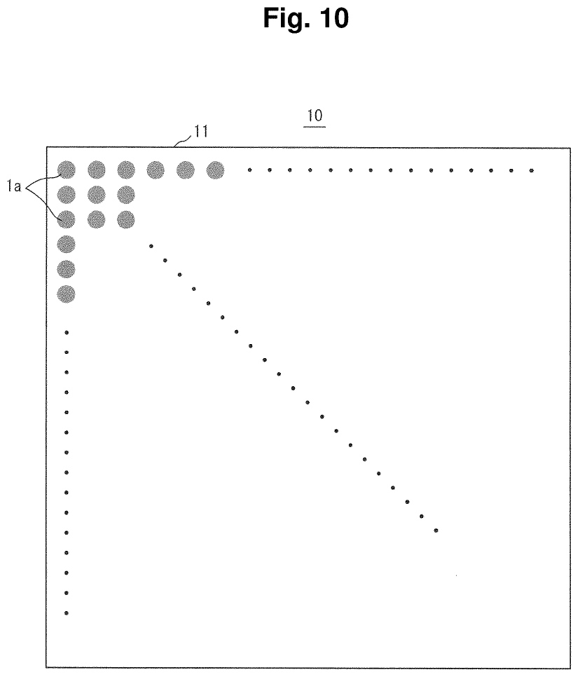

In the first and second embodiments, the structure of the unit cell of the radio wave lens has been described. However, as illustrated in FIG. 10, the radio wave lens 10 can be achieved by two-dimensionally arranging the unit cell 1a on the substrate 11 made of a dielectric such as glass. The substrate 11 is either the dielectric layer 3 or the dielectric layer 4.

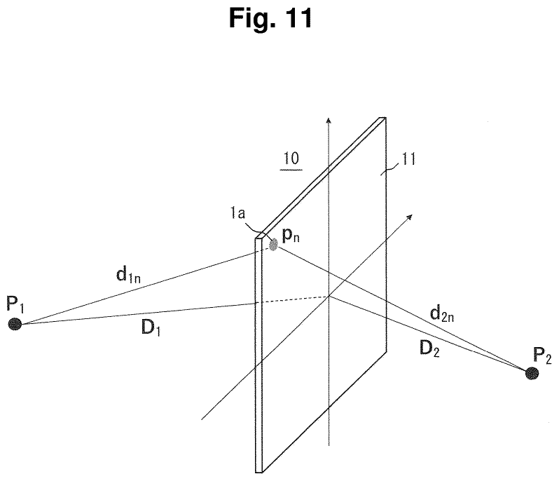

FIG. 11 is a diagram illustrating a state determination method of the unit cell 1a of the radio wave lens 10. The total number of the unit cells 1a constituting the radio wave lens 10 is denoted by N (N is an integer of 2 or more), the wave source of the incoming wave incident on the radio wave lens 10 is denoted by P₁, the reception point at which energy is desired to be guided via the radio wave lens 10 is denoted by P₂, the position of the nth unit cell 1a is denoted by pₙ (n is an integer of 1 to N), the distance from P₁ to an arbitrary reference point of the substrate 11 (the center point of the substrate 11 in the example of FIG. 11) is denoted by D₁, the distance from P₂ to the reference point is denoted by D₂, the distance from P₁ to pₙ is denoted by d₁ₙ, and the distance from P₂ to pₙ is denoted by d₂ₙ. The phase difference Gₙ of the radio wave caused by the optical path length difference between the unit cells at the reception point P₂ is represented Equation below.

$${G}_{n} = 2 π ( ( {d}_{1 n} - {D}_{1} ) + ( {d}_{2 n} - {D}_{2} ) ) / λ \qquad ( 4 )$$

Here, the phase difference Gₙ refers to a phase difference of a radio wave reaching the reception point P₂ via the n-th unit cell 1a with respect to the wave source P₁. λ is the wavelength of the incoming wave. By controlling the transmission state or the reflection state of each unit cell 1a, the radio wave transmitted through the radio wave lens 10 can be guided to the reception point P₂.

For example, the nth unit cell 1a at a position on the substrate 11 where the remainder when the phase difference Gₙ is divided by 2π is o or more and less than a may be set to the transmission state with respect to the incoming wave, and the nth unit cell 1a at a position where the remainder is a or more and less than 2π may be set to the reflection state with respect to the incoming wave. Conversely, the nth unit cell 1a at a position where the remainder is o or more and less than π may be set to the reflection state, and the nth unit cell 1a at a position where the remainder is π or more and less than 2π may be set to the transmission state.

Furthermore, in a case where the distance D₁ is calculated to be sufficiently longer than the size of the radio wave lens 10, it is possible to determine the transmission state or the reflection state of the unit cell 1a assuming a plane wave coming from the direction of a wave source P₁. Furthermore, in a case where the distance D₂ is calculated to be sufficiently longer than the size of the radio wave lens 10, a function of deflecting the transmitted wave in the direction of the reception point P₂ can be realized.

### Fourth Embodiment

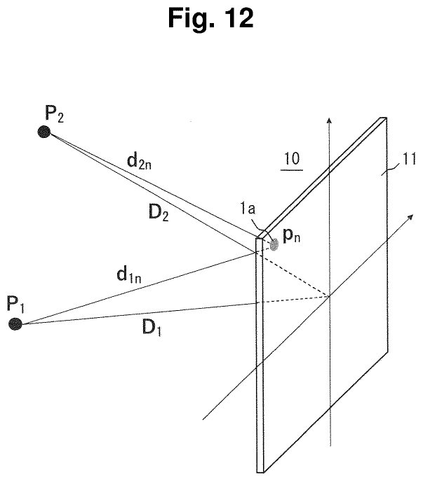

In the third embodiment, the reception point P₂ is set on the side opposite to the wave source P₁ having the radio wave lens 10 therebetween. In the present embodiment, as illustrated in Fig. 12, the reception point P₂ is set on the same side as the wave source P₁. By a similar method to that of the third embodiment, when the transmission state or the reflection state of each unit cell 1a is determined, the reflected wave by the radio wave lens 10 can be guided to the reception point P₂.

In the third and fourth embodiments, the example in which the unit cell 1a is arranged on the substrate is shown, but the unit cell 1b may be arranged.

### Fifth Embodiment

In the first to fourth embodiments, in order to change the state by changing the capacitive component of the unit cells 1a, 1b, it is necessary to apply a voltage to a region where the capacitance component is formed in order to change the dielectric constant of the dielectric layer 2.

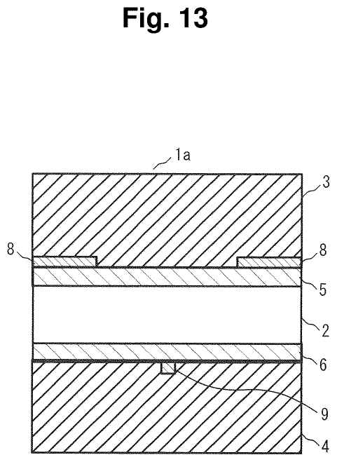

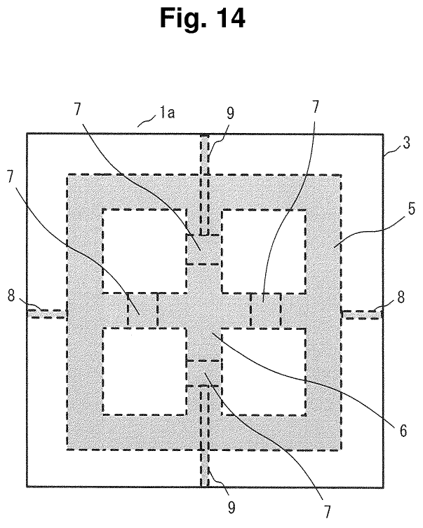

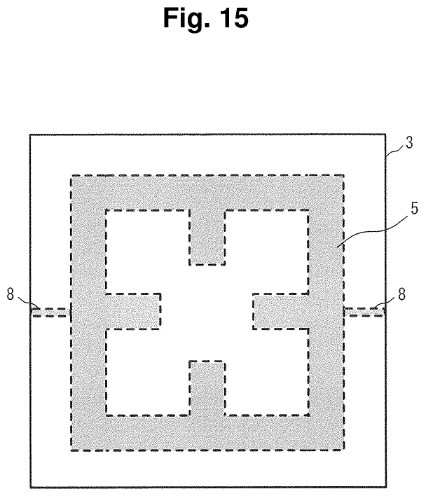

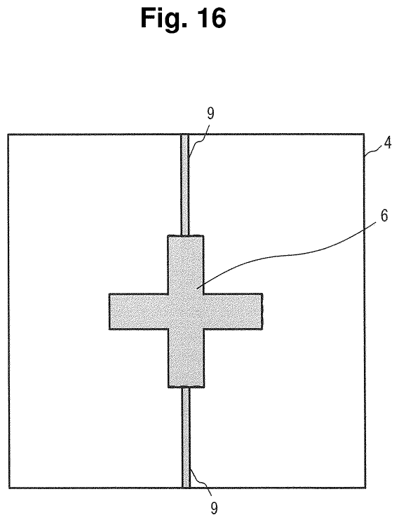

FIG. 13 is a cross-sectional view of a structure in which the control signal lines 8, 9 are arranged in the unit cell 1a described in the first to fourth embodiments, and FIG. 14 is a plan view of a structure in which the control signal lines 8, 9 are arranged in the unit cell 1a. FIG. 15 is a plan view illustrating a pattern of the conductor layer 5 and the control signal line 8, and FIG. 16 is a plan view illustrating a pattern of the conductor layer 6 and the control signal line 9.

The control signal lines 8, 9 made of metal or a conductor such as indium tin oxide (ITO) are formed in the dielectric layers 3, 4 and connected to the conductor layers 5, 6. By applying a voltage across the conductor layers 5, 6 via the control signal lines 8, 9, a voltage is applied to the dielectric layer 2 in a region where a capacitive component between the conductor layers 5, 6 is formed. As a result, the dielectric constant of the dielectric layer 2 can be changed by the voltage. As similar to this, in the case of the unit cell 1b, the control signal lines 8, 9 can be arranged.

As illustrated in FIG. 10, in order to control the planar transmission intensity distribution or reflection intensity distribution of the radio wave as desired by the radio wave lens 10 in which the unit cells 1a, 1b are two-dimensionally arranged, it is necessary to form control signal lines 8, 9 for applying voltages to the unit cells 1a, 1b in a matrix. When the control signal lines 8, 9 are formed in a matrix form, the control signal lines having a component parallel to the electric field component of the incoming wave inhibit coupling between the unit cells 1a, 1b and the incoming wave, and thus, it is not possible to form an intended transmission intensity distribution.

Therefore, in the present embodiment, the control signal lines 8, 9 are formed of a conductive material having higher resistance than the material of the conductor layers 5, 6 constituting the unit cells 1a, 1b. As a result, a radio wave of a high frequency arriving at the radio wave lens is mainly coupled to the unit cells 1a, 1b formed of a low-resistance material, and is not coupled to the high-resistance control signal lines 8, 9, so that the planar transmission intensity distribution of the radio wave can be controlled using the control signal lines 8, 9 as desired.

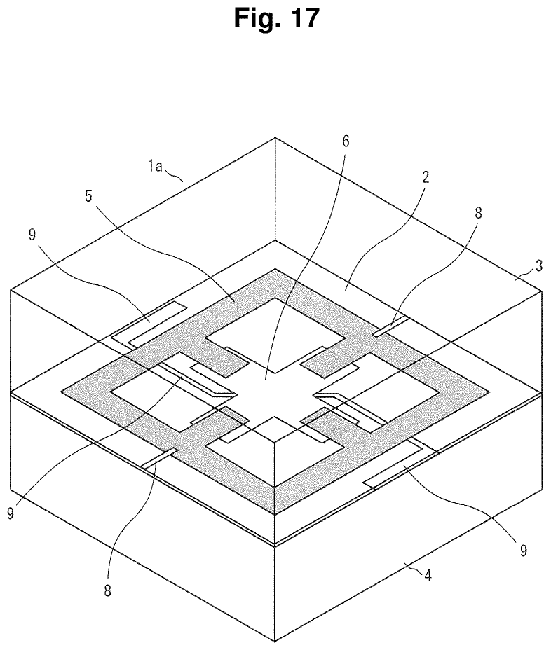

The results of confirming the effects of the present embodiment by electromagnetic field analysis are shown below. FIG. 17 is a perspective view illustrating a model of the unit cell 1a used in an electromagnetic field analysis simulation. Here, alkali-free glass was used as the material of the dielectric layers 3, 4, copper was used as the material of the conductor layers 5, 6, and copper or ITO was used as the material of the control signal lines 8, 9. The sheet resistances of the control signal lines 8, 9 made of ITO are 10 Ω·A or more. As the dielectric layer 2, a liquid crystal having a relative permittivity change width of 2.5 to 3.5 according to the applied voltage was used.

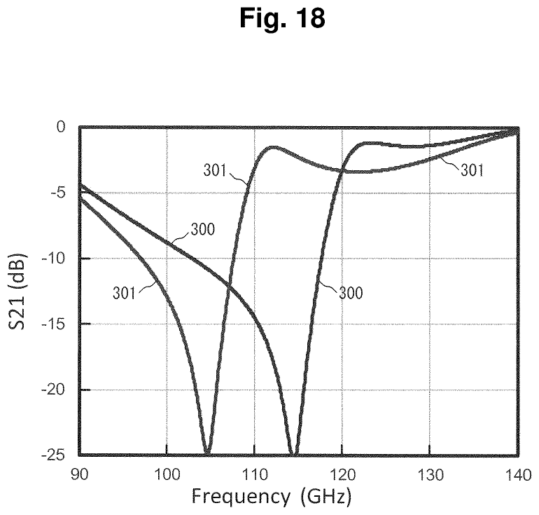

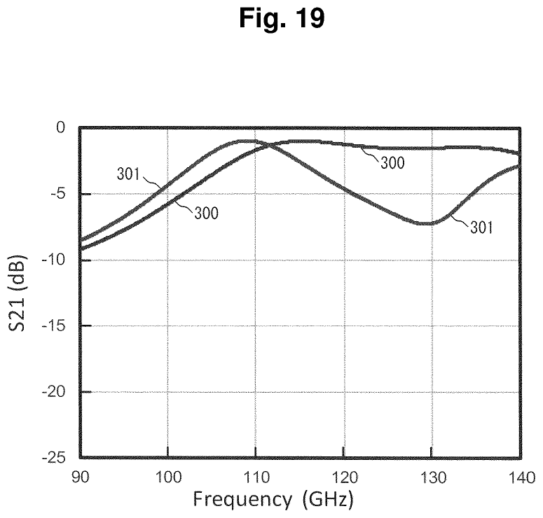

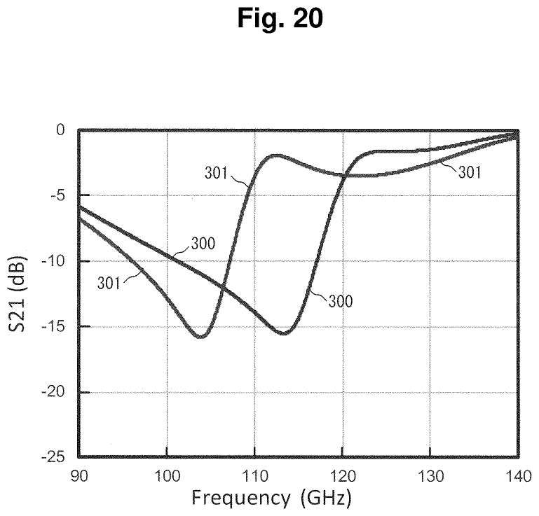

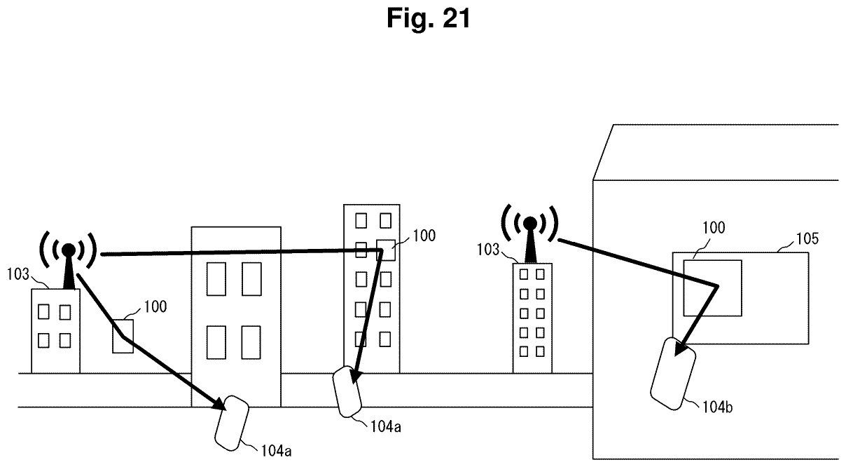

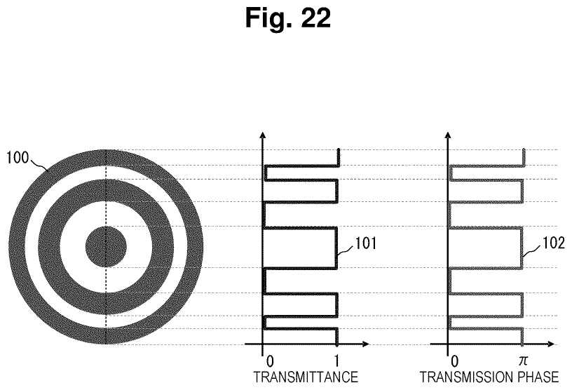

FIG. 18 is a diagram illustrating a transmitted wave intensity characteristic of the unit cell 1a in a case where the control signal lines 8, 9 are absent, FIG. 19 is a diagram illustrating a transmitted wave intensity characteristic of the unit cell 1a in the case of forming the control signal lines 8, 9 made of copper, and FIG. 20 is a diagram illustrating a transmitted wave intensity characteristic of the unit cell 1a in the case of forming the control signal lines 8, 9 made of ITO. In FIGS. 18 to 20, the vertical axis represents the intensity (S21) of the transmitted wave. In FIGS. 18 to 20, reference numeral 300 denotes a characteristic when the relative permittivity er of the dielectric layer 2 is 2.5, and reference numeral 301 denotes a characteristic when the relative permittivity εᵣ is 3.5.

FIG. 18 shows characteristics in the case where the control signal lines 8, 9 are absent, and thus it means that the transmitted wave intensity characteristics change when the dielectric layer 2 having a different relative permittivity er is used. On the other hand, it can be seen that, in a case where the control signal lines 8, 9 are formed of the same copper as the conductor layers 5, 6, even if the relative permittivity er of the dielectric layer 2 is changed by the voltage applied to the control signal lines 8, 9, the transmitted wave intensity characteristic does not change significantly, and controllability is poor. On the other hand, in a case where the control signal lines 8, 9 are formed using high-resistance ITO as a material, the transmitted wave intensity characteristic greatly changes due to a change in the relative permittivity er of the dielectric layer 2. Therefore, according to the present embodiment, it can be seen that the transmitted wave intensity can be controlled by the voltage applied to the control signal lines 8, 9 even when the control signal lines 8, 9 are formed in a matrix.

Some or all of the above-described embodiments may be described as the following supplementary notes, but are not limited to the following.

(Supplementary note 1) A radio wave lens of embodiments of the present invention includes a plurality of unit cells arranged two-dimensionally on a surface of a substrate intersecting an incident radio wave, in which each of the unit cells includes: a first dielectric layer whose dielectric constant is externally controllable; second and third dielectric layers formed so as to sandwich the first dielectric layer therebetween; a first conductor layer formed on a surface of the second dielectric layer in a side of the first dielectric layer so as to be in contact with the first dielectric layer; and a second conductor layer formed on a surface of the third dielectric layer in a side of the first dielectric layer so as to be in contact with the first dielectric layer.

(Supplementary note 2) The radio wave lens according to supplementary note 1, in which each of the unit cells further includes a first control signal line formed in the second dielectric layer and connected to the first conductor layer, and a second control signal line formed in the third dielectric layer and connected to the second conductor layer.

(Supplementary note 3) The radio wave lens according to supplementary note 2, in which a transmission state or a reflection state of each of the unit cells with respect to an incident radio wave is set by a voltage applied to the first and second control signal lines based on a phase difference of the radio wave caused by an optical path length difference of each of the unit cells at a reception point where the radio wave transmitted through the radio wave lens or the radio wave reflected by the radio wave lens reaches.

(Supplementary note 4) The radio wave lens according to supplementary note 3, in which, when the number of the unit cells constituting the radio wave lens is N (N is an integer of 2 or more), a distance from a wave source of the radio wave incident on the radio wave lens to a reference point of the substrate is D₁, a distance from the reception point to the reference point is D₂, a distance from the wave source to an nth (n is an integer of 1 to N) unit cell of the unit cells is d₁ₙ, a distance from the reception point to the nth unit cell is d₂ₙ, a wavelength of the radio wave incident on the radio wave lens is λ, and a phase difference of the radio wave that has passed through the nth unit cell and reached the reception point or the radio wave that has been reflected by the nth unit cell and reached the reception point is Gₙ=2π((d₁ₙ−D₁)+(d₂ₙ−D₂))/π, the nth unit cell at a position where a remainder obtained by dividing the phase difference Gₙ by 2π is o or more and less than a is set to a first state of either a transmission state or a reflection state with respect to the incident radio wave, and the nth unit cell at a position where the remainder is π or more and less than 2π is set to a second state different from the first state between the transmission state and the reflection state with respect to the incident radio wave.

(Supplementary note 5) The radio wave lens according to any one of supplementary notes 2 to 4, in which the first and second control signal lines are made of a conductive material having higher resistance than materials of the first and second conductor layers.

(Supplementary note 6) The radio wave lens according to supplementary note 5, in which the first dielectric layer is made of liquid crystal, the second and third dielectric layers are made of alkali-free glass, the first and second conductor layers are made of copper, and the first and second control signal lines are made of ITO.

(Supplementary note 7) The radio wave lens according to Supplementary note 1, in which the first and second conductor layers have portions facing each other with the first dielectric layer interposed therebetween.

(Supplementary note 8) The radio wave lens according to Supplementary note 1, in which the unit cells each have a rotationally symmetric shape with respect to a rotation axis perpendicular to a stacked structure of the first, second, and third dielectric layers and the first and second conductor layers.

### INDUSTRIAL APPLICABILITY

Embodiments of the present invention can be applied to a technology for controlling a transmission intensity distribution or a reflection intensity distribution of a radio wave.

### REFERENCE SIGNS LIST

1a, 1b Unit cell
2, 3, 4 Dielectric layer
5, 6 Conductor layer
8, 9 Control signal line
10 Radio wave lens
11 Substrate

1.-8. (canceled)

9. A radio wave lens comprising:
a plurality of unit cells arranged two-dimensionally on a surface of a substrate intersecting an incident radio wave, wherein each of the unit cells includes:
a first dielectric layer whose dielectric constant is externally controllable;
second and third dielectric layers formed so as to sandwich the first dielectric layer therebetween;
a first conductor layer formed on a surface of the second dielectric layer in a side of the first dielectric layer so as to be in contact with the first dielectric layer; and
a second conductor layer formed on a surface of the third dielectric layer in a side of the first dielectric layer so as to be in contact with the first dielectric layer.

10. The radio wave lens according to claim 9, wherein each of the unit cells further includes:
a first control signal line formed in the second dielectric layer and connected to the first conductor layer, and
a second control signal line formed in the third dielectric layer and connected to the second conductor layer.

11. The radio wave lens according to claim 10, wherein a transmission state of each of the unit cells with respect to the incident radio wave is set by a voltage applied to the first and second control signal lines based on a phase difference of the radio wave caused by an optical path length difference of each of the unit cells at a reception point where the radio wave transmitted through the radio wave lens reaches.

12. The radio wave lens according to claim 11, wherein, when the number of the unit cells constituting the radio wave lens is N (N is an integer of 2 or more), a distance from a wave source of the radio wave incident on the radio wave lens to a reference point of the substrate is D₁, a distance from the reception point to the reference point is D₂, a distance from the wave source to an nth (n is an integer of 1 to N) unit cell of the unit cells is dᵢₙ, a distance from the reception point to the nth unit cell is d₂ₙ, a wavelength of the radio wave incident on the radio wave lens is λ, and a phase difference of the radio wave that has passed through the nth unit cell and reached the reception point or the radio wave that has been reflected by the nth unit cell and reached the reception point is Gₙ=2π((d₁ₙ−D₁)+(d₂ₙ−D₂))/λ, the nth unit cell at a position where a remainder obtained by dividing the phase difference G₁ by 2π is o or more and less than π is set to a first state of either a transmission state or a reflection state with respect to the incident radio wave, and the nth unit cell at a position where the remainder is π or more and less than 2π is set to a second state different from the first state between the transmission state and the reflection state with respect to the incident radio wave.

13. The radio wave lens according to claim 10, wherein the first and second control signal lines are made of a conductive material having higher resistance than materials of the first and second conductor layers.

14. The radio wave lens according to claim 13, wherein:
the first dielectric layer is made of liquid crystal,
the second and third dielectric layers are made of alkali-free glass,
the first and second conductor layers are made of copper, and
the first and second control signal lines are made of indium tin oxide.

15. The radio wave lens according to claim 9, wherein the first and second conductor layers have portions facing each other with the first dielectric layer interposed therebetween.

16. The radio wave lens according to claim 9, wherein the unit cells each have a rotationally symmetric shape with respect to a rotation axis perpendicular to a stacked structure of the first, second, and third dielectric layers and the first and second conductor layers.

17. The radio wave lens according to claim 10, wherein a reflection state of each of the unit cells with respect to the incident radio wave is set by a voltage applied to the first and second control signal lines based on a phase difference of the radio wave caused by an optical path length difference of each of the unit cells at a reception point where the radio wave reflected by the radio wave lens reaches.

18. The radio wave lens according to claim 17, wherein, when the number of the unit cells constituting the radio wave lens is N (N is an integer of 2 or more), a distance from a wave source of the radio wave incident on the radio wave lens to a reference point of the substrate is D₁, a distance from the reception point to the reference point is D₂, a distance from the wave source to an nth (n is an integer of 1 to N) unit cell of the unit cells is d₁ₙ, a distance from the reception point to the nth unit cell is d₂ₙ, a wavelength of the radio wave incident on the radio wave lens is λ, and a phase difference of the radio wave that has passed through the nth unit cell and reached the reception point or the radio wave that has been reflected by the nth unit cell and reached the reception point is Gₙ=2π((d₁ₙ−D₁)+(d₂ₙ−D₂))/λ, the nth unit cell at a position where a remainder obtained by dividing the phase difference Gₙ by 2π is o or more and less than π is set to a first state of either a transmission state or a reflection state with respect to the incident radio wave, and the nth unit cell at a position where the remainder is a or more and less than 2π is set to a second state different from the first state between the transmission state and the reflection state with respect to the incident radio wave.

19. The radio wave lens according to claim 11, wherein the first and second control signal lines are made of a conductive material having higher resistance than materials of the first and second conductor layers.

20. The radio wave lens according to claim 19, wherein:
the first dielectric layer is made of liquid crystal,
the second and third dielectric layers are made of alkali-free glass,
the first and second conductor layers are made of copper, and
the first and second control signal lines are made of indium tin oxide.

21. The radio wave lens according to claim 12, wherein the first and second control signal lines are made of a conductive material having higher resistance than materials of the first and second conductor layers.

22. The radio wave lens according to claim 21, wherein:
the first dielectric layer is made of liquid crystal,
the second and third dielectric layers are made of alkali-free glass,
the first and second conductor layers are made of copper, and
the first and second control signal lines are made of indium tin oxide.

23. The radio wave lens according to claim 17, wherein the first and second control signal lines are made of a conductive material having higher resistance than materials of the first and second conductor layers.

24. The radio wave lens according to claim 23, wherein:
the first dielectric layer is made of liquid crystal,
the second and third dielectric layers are made of alkali-free glass,
the first and second conductor layers are made of copper, and
the first and second control signal lines are made of indium tin oxide.

25. The radio wave lens according to claim 18, wherein the first and second control signal lines are made of a conductive material having higher resistance than materials of the first and second conductor layers.

26. The radio wave lens according to claim 25, wherein:
the first dielectric layer is made of liquid crystal,
the second and third dielectric layers are made of alkali-free glass,
the first and second conductor layers are made of copper, and
the first and second control signal lines are made of indium tin oxide.

27. A method of operating a radio wave lens, the method comprising:
applying voltages to control signal lines connected to conductor layers in a plurality of unit cells arranged two-dimensionally on a surface of a substrate, wherein each unit cell comprises a first dielectric layer sandwiched between second and third dielectric layers, and first and second conductor layers in contact with the first dielectric layer;
determining a desired reception point for a radio wave;
calculating phase differences for each unit cell based on positions of the unit cells relative to a wave source and the desired reception point;
setting each unit cell to either a transmission state or a reflection state based on the calculated phase differences; and
dynamically adjusting the states of the unit cells to guide the radio wave to the desired reception point as the reception point changes position.

28. A radio wave lens comprising:
a plurality of unit cells arranged two-dimensionally on a surface of a substrate intersecting an incident radio wave, wherein each of the unit cells includes:
a first dielectric layer made of liquid crystal;
second and third dielectric layers made of alkali-free glass, formed so as to sandwich the first dielectric layer therebetween;
a first conductor layer made of copper, formed on a surface of the second dielectric layer in a side of the first dielectric layer so as to be in contact with the first dielectric layer;
a second conductor layer made of copper, formed on a surface of the third dielectric layer in a side of the first dielectric layer so as to be in contact with the first dielectric layer;
a first control signal line made of indium tin oxide, formed in the second dielectric layer and connected to the first conductor layer; and
a second control signal line made of indium tin oxide, formed in the third dielectric layer and connected to the second conductor layer;
wherein the first and second conductor layers have portions facing each other with the first dielectric layer interposed therebetween, forming a capacitive component;
wherein each unit cell has a rotationally symmetric shape with respect to a rotation axis perpendicular to a stacked structure of the first, second, and third dielectric layers and the first and second conductor layers; and
wherein a transmission state or a reflection state of each of the unit cells with respect to the incident radio wave is set by a voltage applied to the first and second control signal lines based on a phase difference of the radio wave caused by an optical path length difference of each of the unit cells at a reception point.
